(19) United States
(12) Patent Application Publication
(10) Pub. No.: US 2002/0077826 A1
(43) Pub. Date: Jun. 20, 2002

(54) Voice communication concerning a local entity

(76) Inventors: Stephen John Hinde, Bristol (GB); Lawrence Wilcock, Malmesbury (GB); Paul St. John Brittan, Claverham (GB); Guillaume Belrose, Bristol (GB)

Correspondence Address: LADAS & PARRY, Suite 2100, 5670 Wilshire Boulevard, Los Angeles, CA, 90036-5679, US

(21) Appl. No.: 09/990,766

(22) Filed: Nov. 21, 2001

(30) Foreign Application Priority Data
Nov. 25, 2000 (GB) 0028804.3
Nov. 25, 2000 (GB) 0028775.5
Nov. 25, 2000 (GB) 0028810.0

(51) Int. Cl. G10L 21/00

(52) U.S. Cl. 704/270

(57) ABSTRACT

A local entity without its own means of voice communication is provided with the semblance of having a voice interaction capability. This is done by providing an associated voice service hosted separately from the entity, the service being initiated when a user comes near the entity. The service uses audio input and output devices that are located either in user-carried equipment or in the locality of the entity. The voice service can be delivered to multiple users simultaneously with the users being joined into the same communication session with the voice service so that all users hear at least some of the same service output. The voice service can be arranged to serve a group of associated entities, not necessarily near each other.

### FIELD OF THE INVENTION

The present invention relates to voice services and in particular, but not exclusively, to a method of providing for voice interaction with a local dumb device.

### BACKGROUND OF THE INVENTION

In recent years there has been an explosion in the number of services available over the World Wide Web on the public internet (generally referred to as the “web”), the web being composed of a myriad of pages linked together by hyperlinks and delivered by servers on request using the HTTP protocol. Each page comprises content marked up with tags to enable the receiving application (typically a GUI browser) to render the page content in the manner intended by the page author; the markup language used for standard web pages is HTML (Hyper Text Markup Language).

However, today far more people have access to a telephone than have access to a computer with an Internet connection. Sales of cellphones are outstripping PC sales so that many people have already or soon will have a phone within reach where ever they go. As a result, there is increasing interest in being able to access web-based services from phones. ‘Voice Browsers’ offer the promise of allowing everyone to access web-based services from any phone, making it practical to access the Web any time and any where, whether at home, on the move, or at work.

Voice browsers allow people to access the Web using speech synthesis, pre-recorded audio, and speech recognition. FIG. 1 of the accompanying drawings illustrates the general role played by a voice browser. As can be seen, a voice browser is interposed between a user 2 and a voice page server 4. This server 4 holds voice service pages (text pages) that are marked-up with tags of a voice-related markup language (or languages). When a page is requested by the user 2, it is interpreted at a top level (dialog level) by a dialog manager 7 of the voice browser 3 and output intended for the user is passed in text form to a Text-To-Speech (TTS) converter 6 which provides appropriate voice output to the user. User voice input is converted to text by speech recognition module 5 of the voice browser 3 and the dialog manager 7 determines what action is to be taken according to the received input and the directions in the original page. The voice input I output interface can be supplemented by keypads and small displays.

In general terms, therefore, a voice browser can be considered as a largely software device which interprets a voice markup language and generate a dialog with voice output, and possibly other output modalities, and/or voice input, and possibly other modalities (this definition derives from a working draft, dated September 2000, of the Voice browser Working Group of the World Wide Web Consortium).

Voice browsers may also be used together with graphical displays, keyboards, and pointing devices (e.g. a mouse) in order to produce a rich “multimodal voice browser”. Voice interfaces and the keyboard, pointing device and display maybe used as alternate interfaces to the same service or could be seen as being used together to give a rich interface using all these modes combined.

Some examples of devices that allow multimodal interactions could be multimedia PC, or a communication appliance incorporating a display, keyboard, microphone and speaker/headset, an in car Voice Browser might have display and speech interfaces that could work together, or a Kiosk.

Some services may use all the modes together to provide an enhanced user experience, for example, a user could touch a street map displayed on a touch sensitive display and say “Tell me how I get here?”. Some services might offer alternate interfaces allowing the user flexibility when doing different activities. For example while driving speech could be used to access services, but a passenger might used the keyboard.

FIG. 2 of the accompanying drawings shows in greater detail the components of an example voice browser for handling voice pages 15 marked up with tags related to four different voice markup languages, namely:

tags of a dialog markup language that serves to specify voice dialog behaviour;

tags of a multimodal markup language that extends the dialog markup language to support other input modes keyboard, mouse, etc.) and output modes (large and small screens);

tags of a speech grammar markup language that serve to specify the grammar of user input; and

tags of a speech synthesis markup language that serve to specify voice characteristics, types of sentences, word emphasis, etc.

When a page 15 is loaded into the voice browser, dialog manager 7 determines from the dialog tags and multimodal tags what actions are to be taken (the dialog manager being programmed to understand both the dialog and multimodal languages 19). These actions may include auxiliary functions 18 (available at any time during page processing) accessible through APIs and including such things as database lookups, user identity and validation, telephone call control etc. When speech output to the user is called for, the semantics of the output is passed, with any associated speech synthesis tags, to output channel 12 where a language generator 23 produces the final text to be rendered into speech by text-to-speech converter 6 and output to speaker 17. In the simplest case, the text to be rendered into speech is fully specified in the voice page 15 and the language generator 23 is not required for generating the final output text; however, in more complex cases, only semantic elements are passed, embedded in tags of a natural language semantics markup language (not depicted in FIG. 2) that is understood by the language generator. The TTS converter 6 takes account of the speech synthesis tags when effecting text to speech conversion for which purpose it is cognisant of the speech synthesis markup language 25.

User voice input is received by microphone 16 and supplied to an input channel of the voice browser. Speech recogniser 5 generates text which is fed to a language understanding module 21 to produce semantics of the input for passing to the dialog manager 7. The speech recogniser 5 and language understanding module 21 work according to specific lexicon and grammar markup language 22 and, of course, take account of any grammar tags related to the current input that appear in page 15. The semantic output to the dialog manager 7 may simply be a permitted input word or may be more complex and include embedded tags of a natural language semantics markup language. The dialog manager 7 determines what action to take next (including, for example, fetching another page) based on the received user input and the dialog tags in the current page 15.

Any multimodal tags in the voice page 15 are used to control and interpret multimodal input/output. Such input/output is enabled by an appropriate recogniser 27 in the input channel 11 and an appropriate output constructor 28 in the output channel 12.

Whatever its precise form, the voice browser can be located at any point between the user and the voice page server. FIGS. 3 to 5 illustrate three possibilities in the case where the voice browser functionality is kept all together; many other possibilities exist when the functional components of the voice browser are separated and located in different logical/physical locations.

In FIG. 3, the voice browser 3 is depicted as incorporated into an end-user system 8 (such as a PC or mobile entity) associated with user 2. In this case, the voice page server 4 is connected to the voice browser 3 by any suitable data-capable bearer service extending across one or more networks 9 that serve to provide connectivity between server 4 and end user system 8. The data-capable bearer service is only required to carry text-based pages and therefore does not require a high bandwidth.

FIG. 4 shows the voice browser 3 as co-located with the voice page server 4. In this case, voice input/output is passed across a voice network 9 between the end-user system 8 and the voice browser 3 at the voice page server site. The fact that the voice service is embodied as voice pages interpreted by a voice browser is not apparent to the user or network and the service could be implemented in other ways without the user or network being aware.

In FIG. 5, the voice browser 3 is located in the network infrastructure between the end-user system 8 and the voice page server 4, voice input and output passing between the end-user system and voice browser over one network leg, and voice-page text data passing between the voice page server 4 and voice browser 3 over another network leg. This arrangement has certain advantages; in particular, by locating expensive resources (speech recognition, TTS converter) in the network, they can be used for many different users with user profiles being used to customise the voice-browser service provided to each user.

A more specific and detailed example will now be given to illustrate how voice browser functionality can be differently located between the user and server. More particularly, FIG. 6 illustrates the provision of voice services to a mobile entity 40 which can communicate over a mobile communication infrastructure with voice-based service systems 4, 61. In this example, the mobile entity 40 communicates, using radio subsystem 42 and a phone subsystem 43, with the fixed infrastructure of a GSM PLMN (Public Land Mobile Network) 30 to provide basic voice telephony services. In addition, the mobile entity 40 includes a data-handling subsystem 45 interworking, via data interface 44, with the radio subsystem 42 for the transmission and reception of data over a data-capable bearer service provided by the PLMN; the data-capable bearer service enables the mobile entity 40 to access the public Internet 60 (or other data network). The data handling subsystem 45 supports an operating environment 46 in which applications run, the operating environment including an appropriate communications stack.

Considering the FIG. 6 arrangement in more detail, the fixed infrastructure 30 of the GSM PLMN comprises one or more Base Station Subsystems (BSS) 31 and a Network and Switching Subsystem NSS 32. Each BSS 31 comprises a Base Station Controller (BSC) 34 controlling multiple Base Transceiver Stations (BTS) 33 each associated with a respective “cell” of the radio network. When active, the radio subsystem 42 of the mobile entity 20 communicates via a radio link with the BTS 33 of the cell in which the mobile entity is currently located. As regards the NSS 32, this comprises one or more Mobile Switching Centers (MSC) 35 together with other elements such as Visitor Location Registers 52 and Home Location Register 52.

When the mobile entity 40 is used to make a normal telephone call, a traffic circuit for carrying digitised voice is set up through the relevant BSS 31 to the NSS 32 which is then responsible for routing the call to the target phone whether in the same PLMN or in another network such as PSTN (Public Switched Telephone Network) 56.

With respect to data transmission to/from the mobile entity 40, in the present example three different data-capable bearer services are depicted though other possibilities exist. A first data-capable bearer service is available in the form of a Circuit Switched Data (CSD) service; in this case a full traffic circuit is used for carrying data and the MSC 35 routes the circuit to an InterWorking Function IWF 54 the precise nature of which depends on what is connected to the other side of the IWF. Thus, IWF could be configured to provide direct access to the public Internet 60 (that is, provide functionality similar to an IAP—Internet Access Provider IAP). Alternatively, the IWF could simply be a modem connecting to PSTN 56; in this case, Internet access can be achieved by connection across the PSTN to a standard IAP.

A second, low bandwidth, data-capable bearer service is available through use of the Short Message Service that passes data carried in signalling channel slots to an SMS unit 53 which can be arranged to provide connectivity to the public Internet 60.

A third data-capable bearer service is provided in the form of GPRS (General Packet Radio Service which enables IP (or X.25) packet data to be passed from the data handling system of the mobile entity 40, via the data interface 44, radio subsystem 41 and relevant BSS 31, to a GPRS network 37 of the PLMN 30 (and vice versa). The GPRS network 37 includes a SGSN (Serving GPRS Support Node) 38 interfacing BSC 34 with the network 37, and a GGSN (Gateway GPRS Support Node) interfacing the network 37 with an external network (in this example, the public Internet 60). Full details of GPRS can be found in the ETSI (European Telecommunications Standards Institute) GSM 03.60 specification. Using GPRS, the mobile entity 40 can exchange packet data via the BSS 31 and GPRS network 37 with entities connected to the public Internet 60.

The data connection between the PLMN 30 and the Internet 60 will generally be through a gateway 55 providing functionality such as firewall and proxy functionality.

Different data-capable bearer services to those described above may be provided, the described services being simply examples of what is possible. Indeed, whilst the above description of the connectivity of a mobile entity to resources connected to the communications infrastructure, has been given with reference to a PLMN based on GSM technology, it will be appreciated that many other cellular radio technologies exist (for example, UTMS, CDMA etc.) and can typically provide equivalent functionality to that described for the GSM PLMN 30.

The mobile entity 40tself may take many different forms. For example, it could be two separate units such as a mobile phone (providing elements 42-44) and a mobile PC (providing the data-handling system 45), coupled by an appropriate link (wireline, infrared or even short range radio system such as Bluetooth). Alternatively, mobile entity 40 could be a single unit.

FIG. 6 depicts both a voice page server 4 connected to the public internet 60 and a voice-based service system 61 accessible via the normal telephone links.

The voice-based service system 61 is, for example, a call center and would typically be connected to the PSTN 56 and be accessible to mobile entity 40 via PLMN 30 and PSTN 56. The system 56 could also (or alternatively) be connected directly to the PLMN though this is unlikely. The voice-based service system 61 includes interactive voice response units implemented using voice pages interpreted by a voice browser 3A. Thus a user can user mobile entity 40 to talk to the service system 61 over the voice circuits of the telephone infrastructure; this arrangement corresponds to the situation illustrated in FIG. 4 where the voice browser is co-located with the voice page server.

If, as shown, the service system 61 is also connected to the public internet 60 and is enabled to receive VoIP (Voice over IP) telephone traffic, then provided the data handling subsystem 45 of the mobile entity 40 has VoIP functionality, the user could use a data capable bearer service of the PLMN 30 of sufficient bandwidth and QoS (quality of service) to establish a VoIP call, via PLMN 30, gateway 55, and internet 60, with the service system 61.

With regard to access to the voice services embodied in the voice pages held by voice page server 4 connected to the public internet 60, if the data-handling subsystem of the mobile entity is equipped with a voice browser 3E, then all that the mobile entity need do to use these services is to establish a data-capable bearer connection with the voice page server 4 via the PLMN 30, gateway 55 and internet 60, this connection then being used to carry the text based request response messages between the server 61 and mobile entity 4. This corresponds to the arrangement depicted in FIG. 3.

PSTN 56 can be provisioned with a voice browser 3B at internet gateway 57 access point. This enables the mobile entity to place a voice call to a number that routes the call to the voice browser and then has the latter connect to the voice page server 4 to retrieve particular voice pages. Voice browser then interprets these pages back to the mobile entity over the voice circuits of the telephone network. In a similar manner, PLMN 30 could also be provided with a voice browser at its internet gateway 55. Again, third party service providers could provide voice browser services 3D accessible over the public telephone network and connected to the internet to connect with server 4. All these arrangements are embodiments of the situation depicted in FIG. 5 where the voice browser is located in the communication network infrastructure between the user end system and voice page server.

It will be appreciated that whilst the foregoing description given with respect to FIG. 6 concerns the use of voice browsers in a cellular mobile network environment, voice browsers are equally applicable to other environments with mobile or static connectivity to the user.

Voice-based services are highly attractive because of their ease of use; however, they do require significant functionality to support them. For this reason, whilst it is desirable to provide voice interaction capability for many types of devices in every day use, the cost of doing so is currently prohibitive.

### SUMMARY OF THE INVENTION

According to one aspect of the present invention, there is provided a method of voice interaction with a nearby entity, comprising the steps of:

(a) associating a group of one or more entities with a separately-hosted voice service;

(b) upon a user approaching near to any entity of the group, initiating provision of the voice service to that user by joining the user into a communication session established for the service and common to all users of the voice service;

the voice service acting as voice proxy for said group with each user joined to the session interacting with the service through spoken dialog and hearing at least some of the same voice-service output as all other users joined to the session.

According to another aspect of the present invention, there is provided a system for enabling verbal communication on behalf of a local entity with a nearby user, the system comprising:

audio output means either forming part of equipment carried by the user, or located in the locality of the local entity;

audio input means either forming part of equipment carried by the user, or located in the locality of the local entity;

communication means over which signals can be transfered respectively to and from the audio output and input means;

a voice service arrangement for providing a voice service associated with the entity but separately hosted, the voice service arrangement being arranged to deliver the voice service by providing voice input and output signals via the communications means to the audio input and output means thereby enabling a user to interact with the voice service through spoken dialog; and

service initiation means for initiating voice service delivery by the voice service arrangement to a user near the local entity;

the voice service arrangement including session control means for joining multiple users each near the same local entity or an entity of a group of associated entities, into a common voice-service communication session in respect of the same local entity or group of entities whereby such users hear at least some of the same voice-service output.

### BRIEF DESCRIPTION OF THE DRAWINGS

A method and apparatus embodying the invention, for communicating with a dumb entity, will now be described, by way of non-limiting example, with reference to the accompanying diagrammatic drawings, in which:

FIG. 1 is a diagram illustrating the role of a voice browser;

FIG. 2 is a diagram showing the functional elements of a voice browser and their relationship to different types of voice markup tags;

FIG. 3 is a diagram showing a voice service implemented with voice browser functionality located in an end-user system;

FIG. 4 is a diagram showing a voice service implemented with voice browser functionality co-located with a voice page server;

FIG. 5 is a diagram showing a voice service implemented with voice browser functionality located in a network between the end-user system and voice page server,

FIG. 6 is a diagram of a mobile entity accessing voice services via various routes through a communications infrastructure including a PLMN, PSTN and public internet;

FIG. 7 is a diagram of a first arrangement for accessing a dumb-entity voice service using contact data received from a beacon associated with the dumb entity;

FIG. 8 is a diagram of a second arrangement for accessing a dumb-entity voice service using contact data received from a beacon associated with the dumb entity;

FIG. 9 is a diagram of a first arrangement for establishing contact with a dumb-entity voice service by passing contact data from user equipment to a receiving device located near the dumb entity;

FIG. 10 is a diagram of a second arrangement for establishing contact with a dumb-entity voice service by passing contact data from user equipment to a receiving device located near the dumb entity;

FIG. 11 is a diagram of a first arrangement for location-based initiation of a dumb-entity voice service;

FIG. 12 is a diagram of a second arrangement for location-based initiation of a dumb-entity voice service;

FIG. 13 is a diagram of an embodiment of the invention in which multiple users receive the same output from a voice browser intrpreting a dumb-entity voice service page; and

FIG. 14 is a functional block diagram of an audio-field generating apparatus;

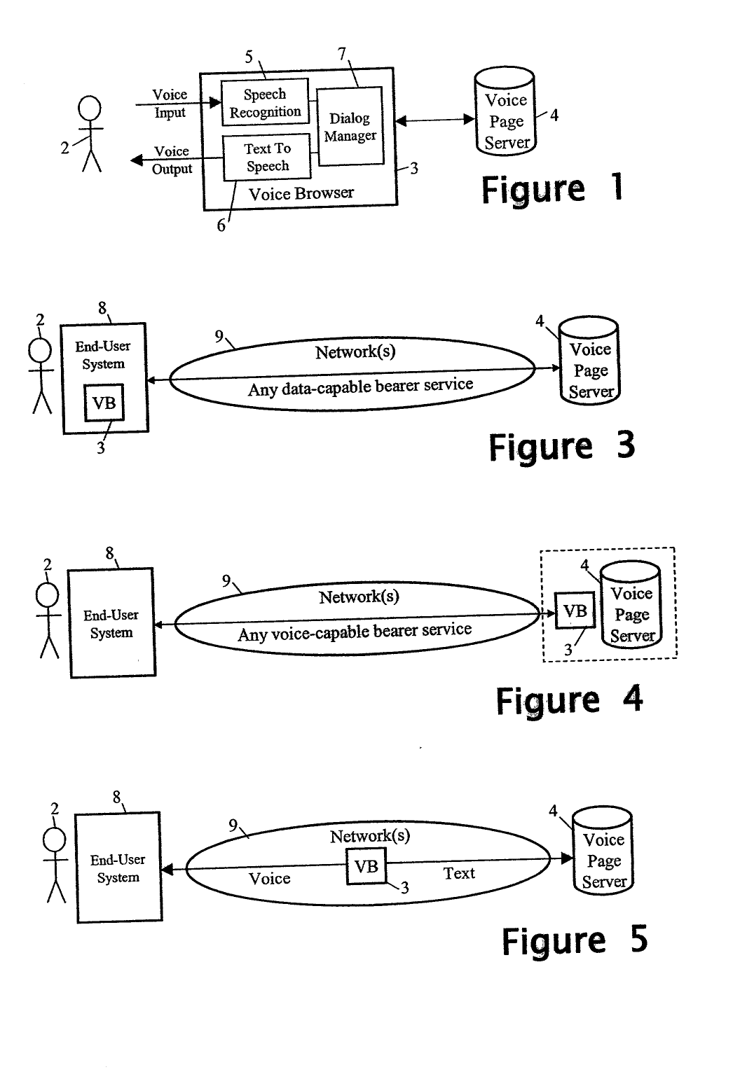

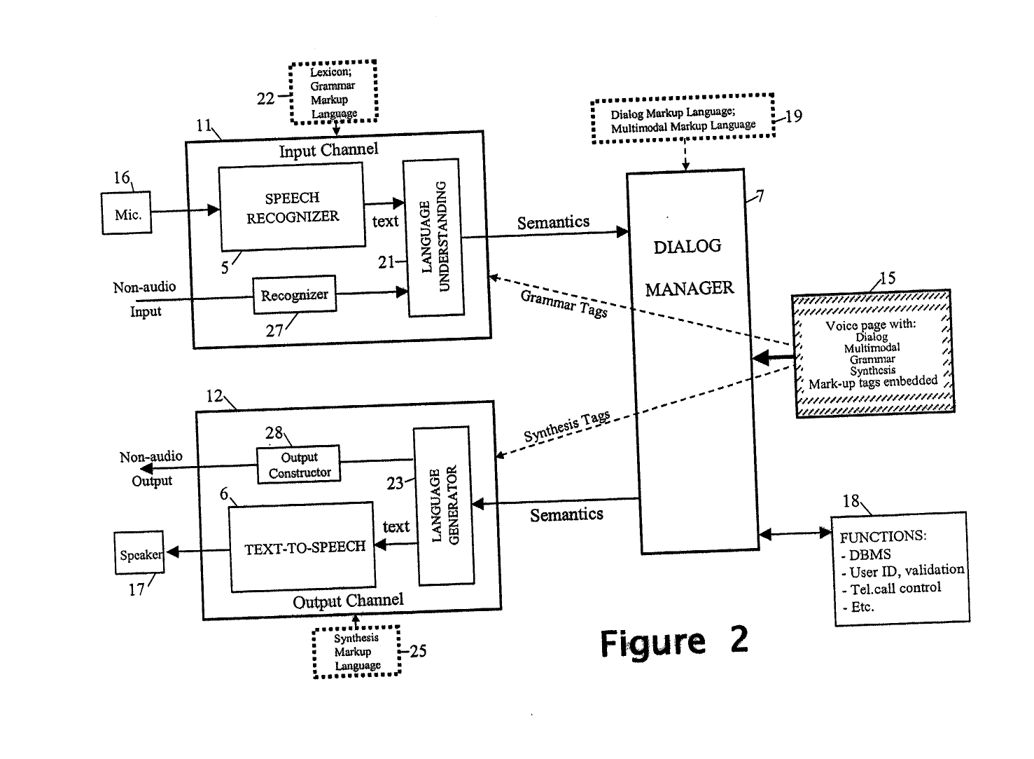

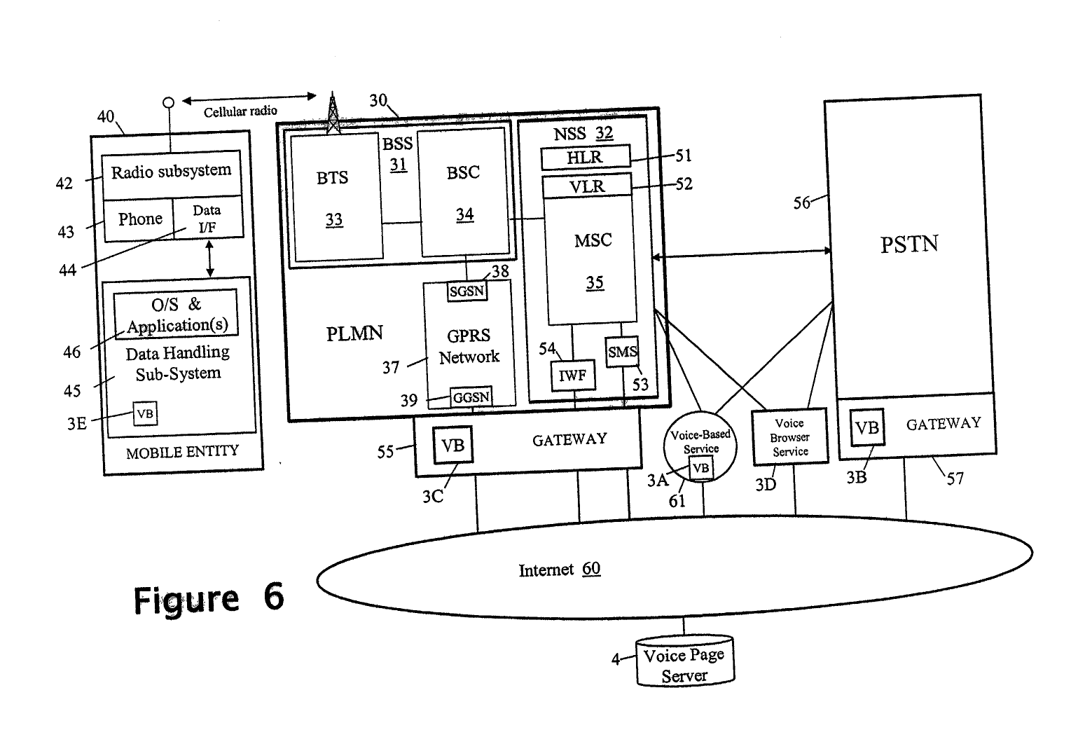

### BEST MODE FOR CARRYING OUT THE INVENTION

In the following description, voice services are described based on voice page servers serving pages with embedded voice markup tags to voice browsers. Unless otherwise indicated, the foregoing description of voice browsers, and their possible locations and access methods is to be taken as applying also to the described embodiments of the invention. Furthermore, although voice-browser based forms of voice services are preferred, the present invention in its widest conception, is not limited to these forms of voice service system and other suitable systems will be apparent to persons skilled in the art.

Before describing an implementation of multi-party voice service session embodying the present invention, various arrangements are described for how a single user can initiate a voice service in respect of a local dumb entity (here a plant 71, but potentially any object, including a mobile object). Three types of arrangements are described:

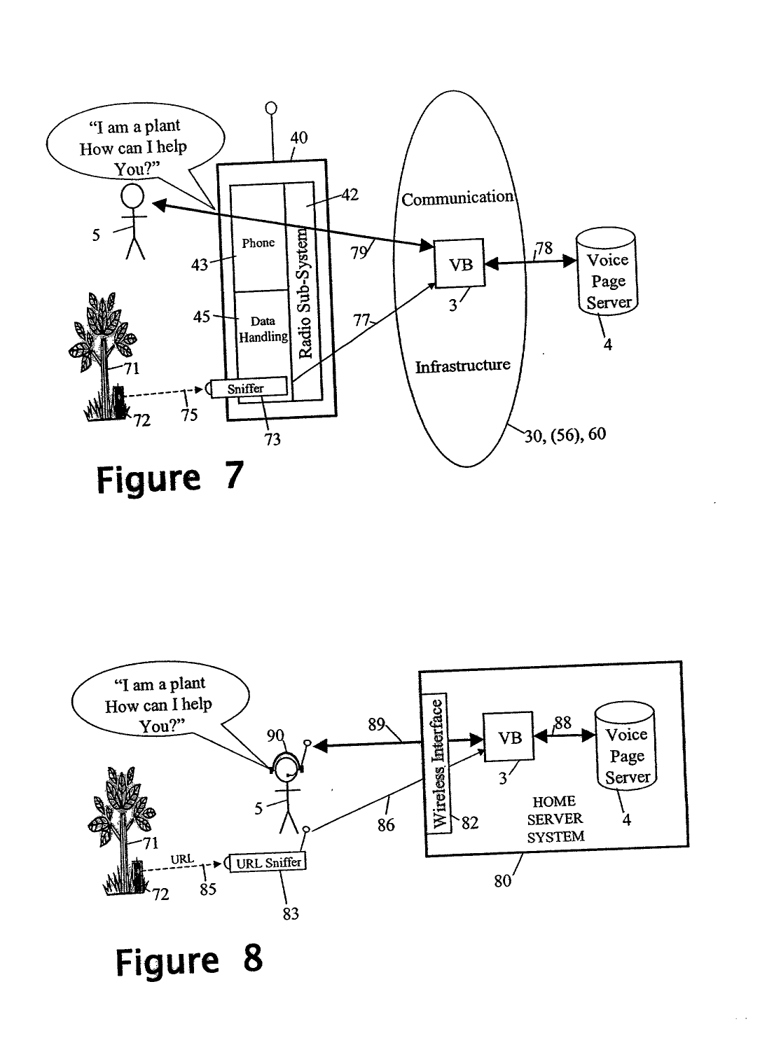

arrangements where a user is provided with voice service contact details from the local dumb entity, for example, via a beacon device located at the entity (FIGS. 7 and 8);

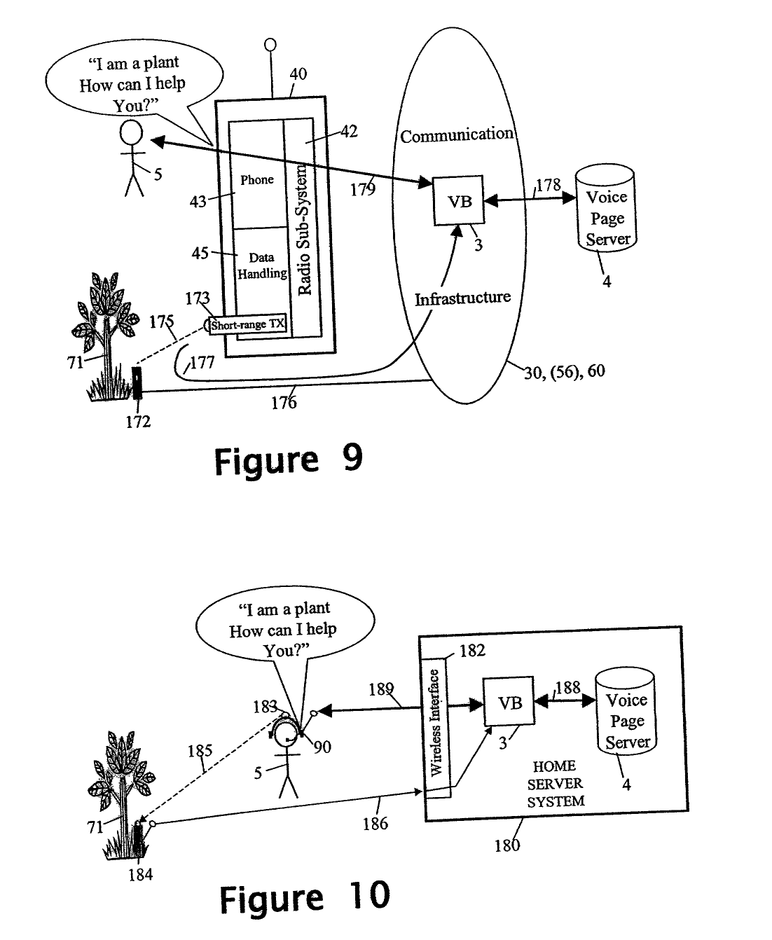

arrangements where a user passes their contact details to a receiving device at the local entity, these details then being passed on to the voice service (FIGS. 9 and 10);

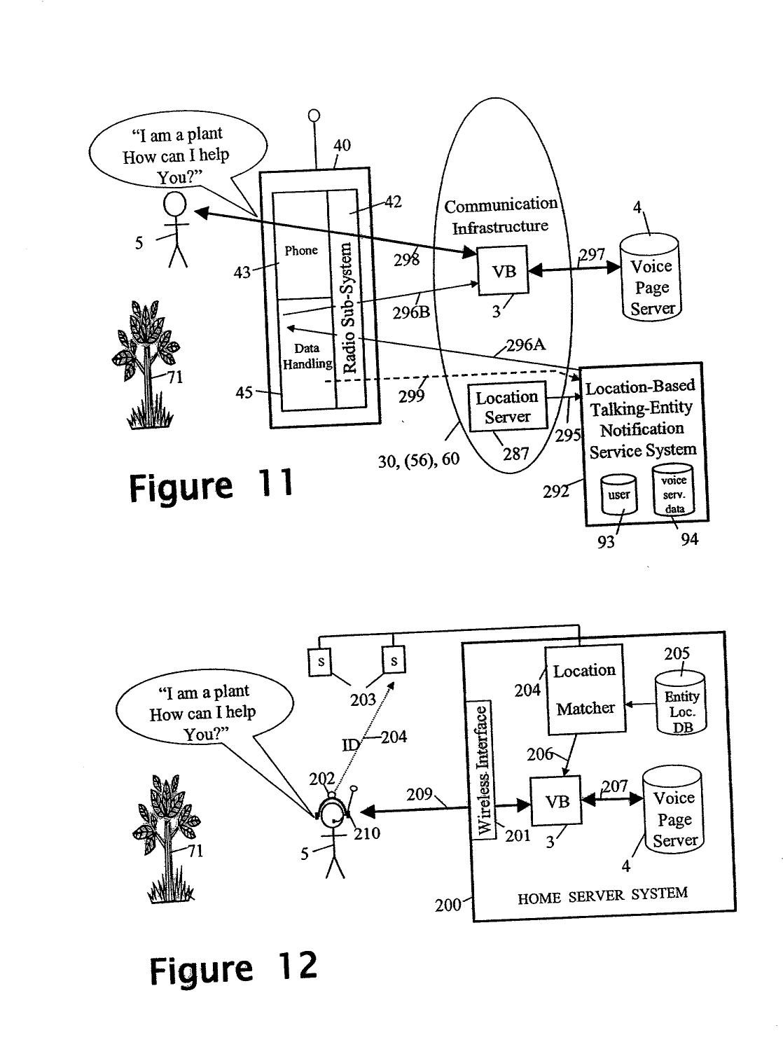

arrangements where the user's location is sensed and when the user is near the dumb entity a service trigger is generated (FIGS. 11 and 12).

Generally, for all the arrangements to be described, the nature of the voice service and, in particular, the dialog followed, will of course, depend on the nature of the dumb entity being given a voice capability.

Voice service contact details provided to user

In the arrangements of FIGS. 7 and 8 a dumb entity, plant 71, is given a voice dialog capability by associating with the plant 71 a beacon device 72 that sends out contact data (either periodically or when it detects persons close by) using a short-range wireless communication system such as an infrared system or a radio-based system (for example, a Bluetooth system), or a sound-based system. The contact data enables suitably-equipped persons nearby to contact a voice service associated with the plant—the voice service thus acts as a voice dialog proxy for the plant and gives the impression to the persons using the service that they are conversing with the plant.

Considering the FIG. 7 arrangement first in more detail, a user 5 is equipped with a mobile entity 40 similar to that of FIG. 6 but provided with a ‘sniffer’ 73 for picking up contact data transmitted by the beacon device 72 (see arrow 75). The contact data is then used by the mobile entity 40 to contact a voice service provided by a voice page server 4 that is connected to the public internet and accessible from mobile entity 40 across the communication infrastructure formed by PLMN 30, PSTN 56 and internet 60. As already described with reference to FIG. 6, a number of possible routes exist through the infrastructure between the mobile entity and voice page server 4 and three ways of using these routes will now be outlined, it being assumed that the voice browser used for interpreting the voice pages served by server 4 is located in the communications infrastructure.

A) The contact data is a URL specific to the voice service for the plant 71. This URL is received by sniffer 73 and passed to an application running in the data handling subsystem 45 which passes the URL and telephone number of the mobile entity 40 to the voice browser 3 over a data-capable bearer connection set up through the communication infrastructure from the mobile entity 40 to the voice browser 3. This results in the voice browser 3 calling back the mobile entity 40 to set up a voice circuit between them and, at the same time, the browser accesses the voice page server 4 to retrieve a first page of the voice service associated with the plant 71. This page (and any subsequent pages) are then interpreted by the voice browser with voice output being passed over the voice circuit to the phone subsystem 43 and thus to user 5, and voice input from the user being returned over the same circuit to the browser. This is the arrangement depicted by the arrows 77 to 79 in FIG. 7 with arrow 77 representing the initial contact passing the voice service URL and mobile entity number to the voice browser, arrow 78 depicting the exchange of request/response messages between the browser 3 and server 4, and arrow 79 representing the exchange of voice messages across the voice circuit between the voice browser 3 and phone subsystem of mobile entity 40. A variant of this arrangement is for the mobile entity to initially contact the voice page server directly, the latter then being responsible for contacting the voice browser and having the latter set up a voice circuit to the mobile entity.

B) The contact data is a URL specific to the voice service for the plant 71. This URL is received by sniffer 73 and passed to an application running in the data handling subsystem 45 which passes the U TRL to the voice browser 3 over a data capable bearer connection established through the communication infrastructure from the mobile entity 40 to the voice browser 3. The browser accesses the voice page server 4 to retrieve a first page of the voice service associated with the plant 71. This page (and any subsequent pages) are then interpreted by the voice browser with voice output being passed as VoIP data to the data-handling subsystem of the mobile entity 40 using the same data-capable bearer connection as used to pass the voice-service URL to the browser 3. Voice input from the user is returned over the same bearer connection to the browser.

C) The contact data is a telephone number specific to the voice service for the plant 71. This telephone number is received by sniffer 73 and passed to an application running in the data handling subsystem 45 which causes the phone subsystem to dial the number. This results in a voice circuit being set up to the voice browser 3 with the browser then accessing the voice page server 4 to retrieve a first page of the voice service associated with the plant 71. This page (and any subsequent pages) are then interpreted by the voice browser with voice output being passed over the voice circuit to the phone subsystem 43 and thus to user 5, and voice input from the user being returned over the same circuit to the browser.

Where the mobile entity 40 is itself equipped with a voice browser 3 then, of course, initial (and subsequent) voice pages can be fetched from the voice page server 4 over a data-capable bearer connection set up through the communications infrastructure. In this case, where resources (such as memory or processing power) at the mobile entity are restricted, the same connection can be used by the voice browser to access remote resources as may be needed, including the pulling in of appropriate lexicons and grammar specifications.

Since the FIG. 7 arrangement uses infrastructure resources that are generally only available at a cost to the user, the data handling subsystem can be arranged to prompt the user for approval via a user interface of the mobile entity 40 before contacting a voice service.

The FIG. 8 arrangement concerns a restricted environment (here taken to be a home environment but potentially any other proprietary space such as an office or similar) where a home server system 80 includes a voice page server 4 and associated voice browser 3, the latter being connected to a wireless interface 82 to enable it to communicate wit h devices in the home over a home wireless network. In this arrangement, the contact data output by the beacon device 72 associated with plant 71 (see arrow 85) is a URL of the relevant voice service page on server 4. This URL is picked up by a URL sniffer 83 carried by user 5 and the URL is relayed over the home wireless network to the home service system and, in particular to the voice browser 3 (see arrow 86). This results in the browser 3 accessing the voice page server 4 to retrieve a first page of the voice service associated with the plant 71. This page (and any subsequent pages) are then interpreted by the voice browser with voice output being passed over the home wireless network to a wireless headset 90 of the user (see arrow 89); voice input from the user 5 is returned over the wireless network to the browser.

As with the FIG. 7 arrangement, the voice browser could be incorporated in equipment carried by the user.

Many variants are, of course, possible to the arrangements described above with reference to FIGS. 7 and 8. For example, rather than using a beacon to present the voice-service contact data to the user, any one or more of the following alternatives can be used:

machine-readable markings representing the contact data are located on or adjacent the entity and are scanned into the user's equipment (a scanner replaces the sniffer of the described arrangements);

a visual, audible or other human-discernable representation of the contact data is presented to the user with the latter then inputting the contact data in their equipment. (a user input device replaces the sniffer of the described arrangements).

Typically, the user will be close enough to the dumb entity to be able to establish voice communication (were the dumb entity capable of it) before receiving the contact data.

In another variant, rather than voice input and output being effected via the user equipment (mobile entity for the FIG. 7 arrangement, wireless headset 90 for the FIG. 8 arrangement), this is done using local loudspeakers and microphones connected by wireline or by the wireless network with the voice browser. Alternatively, voice input and output can be differently implemented from each other with, for example, voice input being done using a microphone carried by the user and voice output done by local loudspeakers.

Receiving Device at Local Entity

In both the arrangements shown in FIGS. 9 and 10 the plant 71 is given a voice dialog capability by associating with the plant 71 a receiving device 172 for receiving user-related contact data from user-carried equipment using a short-range wireless communication system such as an infrared system or a radio-based system (for example, a Bluetooth system), or a sound-based system. The contact data enables a voice service associated with the plant to be placed in communication with the user through a communications infrastructure—the voice service thus acts as a voice dialog proxy for the plant and gives the impression to the persons using the service that they are conversing with the plant. The user-related contact data can be a telephone number or data address of the user's equipment, or it can take the form of a user identifier which is used to look up an access number or address of the user's equipment using a user database.

Considering the FIG. 9 arrangement first in more detail, a user 5 is equipped with a mobile entity 40 similar to that of FIG. 6 but provided with a short-range wireless transmitter 173 (such as an infrared transmitter) for sending user-related contact data to a complementary receiving device 172 located at or near the plant 71 (see arrow 175). The receiving device 172 is connected to the internet 60 by any appropriate connection (wireline or wireless). The contact data received by the receiving device 172 is used to establish contact, across the communication infrastructure formed by PLMN 30, PSIN 56 and internet 60, between the user's mobile entity 40 and a voice service provided by a voice page server 4 that is connected to the public internet (the PSTN 56 may or may not be involved in this link up). As already described with reference to FIG. 6, a number of possible routes exist through the infrastructure between the mobile entity and voice page server 4 and various ways of using these routes will now be outlined that differ according to the location of the voice browser 3 used to interpret the voice pages served by the server 4, and what the receiving device 172 does with the user-related contact data it receives.

A) The contact data is passed by the receiving device 172 to a voice browser 3 located in the communications infrastructure together with the URL of the voice service for the plant 71, this service being in the form of voice pages hosted on voice page server 4. The contact data is either a telephone number associated with the phone functionality 43 of the mobile entity or a current data address for contacting the data-handling subsystem of the mobile entity. Where the contact data is a telephone number, the voice browser calls the mobile entity to set up a voice circuit with the latter; alternatively, the voice browser can use an SMS service to send the user a number to call back (the advantage of this is that main call charge will be carried by the user). At the same time, the browser accesses the voice page server 4 to retrieve a first page of the voice service associated with the plant 71. This page (and any subsequent pages) are then interpreted by the voice browser with voice output being passed over the voice circuit to the phone subsystem 43 and thus to user 5, and voice input from the user being returned over the same circuit to the browser. This is the arrangement depicted by the arrows 177 to 179 in FIG. 9 with arrow 177 representing the initial passing of the user-related contact data and the voice service URL to the voice browser, arrow 178 depicting the exchange of request/response messages between the browser 3 and server 4, and arrow 179 representing the exchange of voice messages across the voice circuit between the voice browser 3 and phone subsystem of mobile entity 40. Where the contact data is a data address, the operation is similar to that described above but now the voice browser uses a data-capable bearer service through the communication infrastructure to initiate a session with a packetised voice application (e.g. VoIP) running in the data-handling subsystem 45 of the mobile entity 40 in order to exchange voice input/output with the mobile entity.

Where the voice browser sets up the voice circuit or data connection then either the user will have to have given sufficient data and authorisation for the user's account with the PLMN to be charged, or else the charge will be borne by the party responsible for the voice browser or the voice service, though arrangements may have been pre-established by these parties for charging the user at least for the call charge itself.

A variant on the foregoing is where the voice browser has access to user data (in particular, to an access code or number for the user's equipment) based on knowing the user's identity. In this case, the user-related contact data need only comprise the user's identity though generally a user-input authorisation code will also be required for accessing the user data. The user data can be associated with a specific voice browser with which the user is registered (in which case the browser's contact information would need to form an element of the user-related contact data); alternatively, the user data could be more generally held, for example, as part of the data held on mobile subscribers by the PLMN operator in HLR 51 (FIG. 6), though again user-authorisation will generally be required for the voice browser to access the information.

B) The user-related contact data (in any of the forms discussed above) is passed by the receiving device 172 to the voice page server 4 which is then responsible for initiating contact with the mobile entity 40. Where the voice pages are to be interpreted by a voice browser located at the voice page server or in the communications infrastructure (including any connected service system), then the voice browser passes the contact data (and, of course, its own URL) to the voice browser and matters proceed as described above in (A). Where the voice browser is located in the mobile entity 40 (an application running in the data handling subsystem 45), then the voice page server 4 can use the contact data to establish a data connection through the communications infrastructure with the data-handling subsystem 45 for the transfer of voice pages to the voice browser and the receipt of text-based requests from the latter.

C) The user-related contact data can be used by the receiving device 172 to pass the URL of its voice service to the mobile entity (for example, using an SMS service or a data connection through the communications infrastructure). The mobile entity is then responsible for connecting to the voice service, either through the intermediary of a voice browser 3 in the communications infrastructure, or directly by a data connection (in the case where the voice browser is in the mobile entity) or a voice connection (in the case where the voice browser is at the voice page server 4).

Where the mobile entity 40 is itself equipped with a voice browser 3 but resources (such as memory or processing power) at the mobile entity are restricted, the data connection used by the voice browser to receive voice pages can also be used to access remote resources as may be needed, including the pulling in of appropriate lexicons and grammar specifications.

Generally, the user will only operate the short-range transmitter 173 when wanting to converse with an entity (plant 71). However, it would also be possible to arrange for the user's contact data to be continually transmitted; in this case, since spurious entities of no interest to the user may then pick up the contact data, the voice browser 3 is preferably arranged to confirm with the user that they wish to talk to a particular voice service before communication is allowed to go ahead.

The FIG. 10 arrangement concerns a restricted environment (here taken to be a home environment but potentially any other proprietary space such as an office or similar) where a home server system 180 includes a voice page server 4 and associated voice browser 3, the latter being connected to a wireless interface 182 to enable it to communicate with devices in the home over a home wireless network. In this arrangement, user-related contact data in the form of a user identity is output by a forward-facing infrared transmitter 183 mounted on a wireless headset 190 worn by the user. The contact data is picked up by receiving device 184 located at or near plant 71 when the user is nearby and facing the plant (see dashed arrow 185). The receiving device sends the contact data, together with the URL of the voice service associated with the plant 71, over the home wireless network to the server system 180 and, in particular, to voice browser 3 (see arrow 186). This results in the browser 3 accessing the voice page server 4 to retrieve a first page of the voice service associated with the plant 71. This page (and any subsequent pages) are then interpreted by the voice browser with voice output being passed over the home wireless network to the wireless headset 190 of the user (see arrow 189); voice input from the user 5 is returned over the wireless network to the browser.

As with the FIG. 9 arrangement, the voice browser could be incorporated in equipment carried by the user.

Many variants are, of course, possible to the arrangements described above with reference to FIGS. 9 and 10. For example, rather than using a short-range wireless link to pass the user-related contact data to the receiving device, the latter could be provided with other forms of input means such as a smart card reader, magnetic card reader, keyboard, or even a voice input arrangement (in this case, the captured voice input is supplied to a speech recogniser, generally over the communications infrastructure).

In another variant, rather than voice input and output both being effected via the user equipment (mobile entity for the FIG. 9 arrangement, wireless headset 190 for the FIG. 10 arrangement), voice output or input could be done using local loudspeakers or microphones respectively, connected by the communications infrastructure (for FIG. 10, this is the home wireless network though wireline connections are, of course, possible). For example, voice input being done using a microphone carried by the user and voice output done by local loudspeakers.

Location bases Service Initiation

In both arrangements shown in FIGS. 11 and 12, plant 71 is given a voice dialog capability by associating a voice service with the plant 71, this service being triggered, or its availability signalled, whenever the location of the user is determined to be near the plant 71. The voice service acts as a voice dialog proxy for the plant and gives the impression to the persons using the service that they are conversing with the plant.

Considering the FIG. 11 arrangement in more detail, a user 5 is equipped with a mobile entity 40 similar to that of FIG. 6. The user is registered with a location-based talking-entity notification service system 292 accessible to the mobile entity 40 over a data-capable bearer connection passing via the communications infrastructure comprising the mobile network 30 and the internet 60 (potentially with the interposition of the public telephone network 56). The service system 292 stores user profile data in database 293 and voice service data in database 294, this voice service data comprising for each entity (such as plant 71) for which a voice service is available, contact data (such as URL) for the voice service and possibly data about the type of information provided by the voice service. In the present example, the voice services are provided by voice pages, that is, text based pages marked up with voice markup tags and intended to be interpreted into speech by a voice browser 3, shown in FIG. 3 as being part of the communications infrastructure, though other locations are possible.

The service system 292 is authorised by the user to request and receive location updates relating to the mobile entity 40 from a location server, here shown as a network-based location server 287. The user activates the service system by an appropriate message passed over the data-capable bearer connection, thereby to permit the service system to receive continual updates, from location server 287, on the user's location. The service system compares the user's current location with the location of the voice-enabled entities listed in database 294 and when the user is within a specified range of an entity, a ‘hit’ is signalled. The service system 292 can be arranged to filter out ‘hits’ that relate to voice services of no interest to the user, as judged by the user-profile data held in database 293.

Upon a ‘hit’ being signalled in the service system, action is taken to inform the user who may then access the voice service concerned to talk to the corresponding entity local to the user—here, plant 71. This can be achieved in a number of ways, several of which are outlined below in items (A) to (D):

(A) Contact data for the voice service is sent by the service system 292 to the mobile entity through the communications infrastructure over a data-capable bearer service (see arrow 296A). The contact data preferably includes information about the local entity and the voice service (as retrieved from database 294). An application running in the data-handling subsystem 45 of the mobile entity 40 receives the contact data and notifies the user 5 of this ‘hit’ through a user interface of the mobile entity 40. The user indicates whether or not the voice service is to be contacted. If the indication is positive, then voice contact is established with the voice service, for example in any of the following ways:

(i) The contact data is a URL specific to the voice service for the plant 71. This URL is passed by the mobile entity, together with the telephone number of the mobile entity 40, to the voice browser 3 over a data-capable bearer connection set up through the communication infrastructure from the mobile entity 40 to the voice browser 3. This results in the voice browser 3 calling back the mobile entity 40 to set up a voice circuit between them and, at the same time, the browser accesses the voice page server 4 to retrieve a first page of the voice service associated with the plant 71. This page (and any subsequent pages) are then interpreted by the voice browser with voice output being passed over the voice circuit to the phone subsystem 43 and thus to user 5, and voice input from the user being returned over the same circuit to the browser. This is the arrangement depicted by the arrows 296B, 297 and 298 in FIG. 11 with arrow 296B representing the initial contact passing the voice service URL and mobile entity number to the voice browser, arrow 297 depicting the exchange of request/response messages between the browser 3 and server 4, and arrow 298 representing the exchange of voice messages across the voice circuit between the voice browser 3 and phone subsystem of mobile entity 40. A variant of this arrangement is for the mobile entity to initially contact the voice page server directly, the latter then being responsible for contacting the voice browser and having the latter set up a voice circuit to the mobile entity.

(ii) The contact data is a URL specific to the voice service for the plant 71. This URL is passed by the mobile entity 40 to the voice browser 3 over a data capable bearer connection established through the communication infrastructure from the mobile entity 40 to the voice browser 3. The browser accesses the voice page server 4 to retrieve a first page of the voice service associated with the plant 71. This page (and any subsequent pages) are then interpreted by the voice browser with voice output being passed as VoIP data to the data-handling subsystem of the mobile entity 40 using the same data-capable bearer connection as used to pass the voice-service URL to the browser 3. Voice input from the user is returned over the same bearer connection to the browser.

(iii) The contact data is a telephone number specific to the voice service for the plant 71. This telephone number is used by the application running in the data handling subsystem 45 to cause the phone subsystem 43 to dial the number. This results in a voice circuit being set up to the voice browser 3 with the browser then accessing the voice page server 4 to retrieve a first page of the voice service associated with the plant 71. This page (and any subsequent pages) are then interpreted by the voice browser with voice output being passed over the voice circuit to the phone subsystem 43 and thus to user 5, and voice input from the user being returned over the same circuit to the browser.

Where the mobile entity 40 is itself equipped with a voice browser 3 then, of course, initial (and subsequent) voice pages can be fetched from the voice page server 4 over a data-capable bearer connection set up through the communications infrastructure. In this case, where resources (such as memory or processing power) at the mobile entity are restricted, the same connection can be used by the voice browser to access remote resources as may be needed, including the pulling in of appropriate lexicons and grammar specifications.

(B) Instead of the voice service contact data being sent to the mobile entity, only brief details of the local entity and related voice service are sent to the mobile entity over a data-capable bearer connection. As in (A), the user is asked to indicate whether or not the voice service is to be contacted. The user's response is returned to the service system 292 which, if the response is positive, is then responsible for instructing the voice browser 3 to retrieve voice pages from the voice page server for the relevant voice service and interpret these pages to the mobile entity over an appropriate connection. This latter connection can either be a data-capable bearer connection carrying VoIP or similar voice data packets, or a voice circuit established by telephoning the mobile entity (it being assumed that the telephone number of the mobile entity is known to the service system and passed to the voice browser 3). The voice browser 3 need not be located in the infrastructure and could conveniently be part of the service system 292 itself. The initial notification of the ‘hit’ that is sent to the user could be sent as a voice message over a voice circuit established between the service system 292 and the mobile entity 40, the notification being, for example, a marked-up voice page interpreted by a voice browser 3 in the service system or the communications infrastructure.

A variant on the above is for the service system to send the contact data for the voice service to the voice browser 3 at the same time as notifying the user of the ‘hit’. The notification would also include the address of the voice browser and an identifier associated with the voice service details of the ‘hit’. In this case, when the user gives a positive indicates they want to listen to the voice service, mobile entity 40 contacts the voice browser, sending the identifier thereby enabling the voice browser to access the desired voice service.

(C) The contact data of the voice service, in the form of a URL, is sent to the voice browser 3 together with any other available information about the voice service and contact details for the mobile entity (either a telephone number or data address). The voice browser is then responsible for notifying the user of the voice service ‘hit’ and acting upon a positive response from the user, to access the voice service and interpret the voice pages to the user (voice connectivity between the voice browser and user being established in any of the ways already indicated above). Instead of the user contact data being a telephone number or data address, it could take the form of a user identifier which the voice browser uses to look up an access number or address of the user's equipment using a user database associated with the voice browser or some other element of the communications infrastructure.

(D) Contact data for the user is sent to the voice service at the voice page server 4 and the latter is responsible for contacting the user (which will generally be done via a network voice browser 3 unless the mobile entity 40 is itself provided with voice browser functionality). Contact with a network voice browser is made over a data connection whereas contact with the mobile entity 40 from the browser 3 will either be via voice circuit or a data-capable bearer connection carrying VoIP packets or equivalent.

Of course, the step of notifying the user of a ‘hit’ and ascertaining whether or not they wish to access the voice service concerned can be skipped, the contact data (and any other necessary data) being sent directly to the voice browser 3 for immediate action to access the voice service and establish voice contact with the user. In contrast, rather than the user's location being determined on a continuous basis and ‘hits’ being continuously looked for, user-location determination and ‘hit’ determination could be carried out by the service system 292 on a one-off basis only when specifically asked for by the user (as indicated by dashed arrow 299 in FIG. 11).

The FIG. 12 arrangement concerns a restricted environment (here taken to be a home environment but potentially any other proprietary space such as an office or similar) where a home server system 200 includes a voice page server 4 and associated voice browser 3, the latter being connected to a wireless interface 201 to enable it to communicate with devices in the home over a home wireless network.

The home is equipped with means for determining the location of identified individuals at least in terms of the room they are in. In the illustrated arrangement, these means comprise infrared sensors 203 arranged to pick up user identity signals emitted (arrow 204) from an infrared beacon 202 carried by each home occupant—in FIG. 12 the user 5 is shown as carrying beacon 202 on a wireless headset 210. Any other suitable location-determining means can be used and the location resolution can, with current technology, be made much more accurate than simple room location, as will be appreciated by persons skilled in the art.

The sensors 203 pass user location information to location matcher 204 which is part of the home server system, the information being passed by a wired network or by using the home wireless radio network. This location information will typically comprise the identity of the user and the identity of the sensor 3 picking up the user ID; the location matcher is programmed with the location of each sensor 3 and thus can determine the location of the identified user. The location matcher 204 has an associated store 205 holding data about each dumb entity (such as plant 291) which has an associated voice service; this data comprises the location of the entity in the home and the URL on voice page server 4 of the corresponding voice service home page.

The location matcher 204 compares the sensor-detected location of user 5 with the entity location data held in store 205 and when the user moves close to one of these entities (e.g. plant 71), a ‘hit’ is determined and the UIRL of the corresponding voice service is output (arrow 206) to the voice browser 3. This results in the browser 3 accessing the voice page server 4 to retrieve a first page of the voice service associated with the plant 71. This page (and any subsequent pages) are then interpreted by the voice browser with voice output being passed over the home wireless network to the wireless headset 210 of the user (see arrow 209); voice input from the user 5 is returned over the wireless network to the browser.

Rather than the user being spoken to every time they come close to a voice-enabled entity, the voice browser could simply “bleep” to the user when they moved close to such an entity. The browser would then await a response from the user indicating that they desired to hear from the entity concerned before accessing the corresponding voice pages from server 4. An alternative approach is to have user control activation of the infrared beacon 202 which, instead of transmitting user ID continuously, would only do so when activated by the user; the user would then only active the beacon 102 when they wished to talk to a nearby entity.

As with the FIG. 11 arrangement, the voice browser could be incorporated in equipment carried by the user.

Many variants are, of course, possible to the arrangements described above with reference to FIGS. 11 and 12. For example, with respect to the FIG. 11 arrangement, location determination could be done at the mobile entity 40 (using, for example, a GPS system) or else the location server could be arranged to supply the location information to the mobile entity rather than the service system. The user can then either control the sending of their location data to the service system or can effect location matching in the mobile entity itself, the service system simply being periodically asked to provide location data about dumb entities within the general locality of the user. Whatever the case, location matching will typically be limited to a user-entity range corresponding to a distance over which the user could establish voice communication with the entity (were the dumb entity capable of it).

The identity of the user can be sent to the voice service itself and used by the latter to look up user profile data which is then used to customise the voice service to the user.

Rather than voice input and output being effected via the user equipment (mobile entity for the FIG. 11 arrangement, wireless headset 290 for the FIG. 12 arrangement), this can be done using local loudspeakers and microphones connected by wireline or by the wireless network with the voice browser. Alternatively, voice input and output can be differently implemented from each other with, for example, voice input being done using a microphone carried by the user and voice output done by local loudspeakers.

Voice Service Sessions

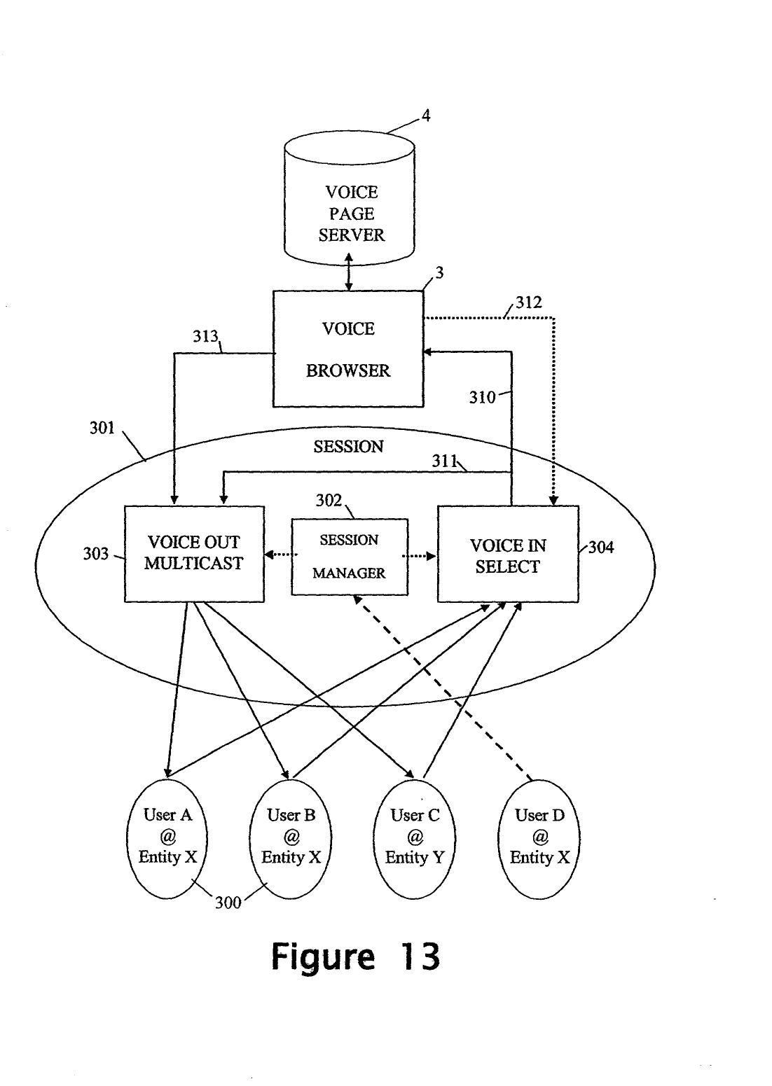

For all of the above arrangements described with respect to FIGS. 7 to 12 and their variants, the voice service associated with plant 71 is configured such that when a user contacts the voice service (or it is contacted on the user's behalf) the user is joined into a communication session with any other users currently using the voice service associated with the plant 71 such that all users at least hear the same voice output of the voice service. This can be achieved by functionality at the voice page server (session management being commonly effected at web page servers) but only to the level of what page is currently served to the voice browser being used by each user. This maybe acceptable where a page is simple and without dialog branches as there is no opportunity for divergence between users. However, in order to facilitate the use of voice pages with more complex structures, it is preferred to implement the common session feature at a voice browser so as to be able to provide the voice service output determined by the dialog manager thereby ensuring all users hear the same output at the same time. Such an embodiment is illustrated in FIG. 13 where a session functionality 301 is associated with voice page server 4 and voice browser 3 arranged to provide voice services in respect of at least two entities X and Y.

In FIG. 13, users A and B located at local entity X (see 300) are depicted as joined to a common session in respect of the voice service for entity X; a third user C, also at entity X, is shown as initiating contact with the voice service.

Considering what happens when a user first contacts the voice service associated with entity X, the service request from the user (or on their behalf) is routed to a session manager 302 (see dashed arrow from user D at entity X); this may involve re-routing of the request from the voice browser 3 or voice page server 4 if the request is so addressed, but preferably the service contact data directly routes service requests to the session manager 302. The voice-service request is registered by the session manager 302 along with user address data that is passed to voice-output multicast block 303 to enable it to send output from the voice browser 3 (see arrow 313) to all the users currently registered with the session. Session manager 302 is also responsible for removing users from a session either as a result of a session exit input from the user or because the connection with the user is lost or no session activity has occurred for a preset period.

With respect to voice input by session members, in the present example, a selection block 304 determines which voice input stream (that is, the input from which user) is to be passed to the voice browser to control the course of the dialog with the entity X. This avoids conflict problems that would occur if more than one registered user was to speak at the same time and the multiple inputs were all passed to the voice browser. The selected input voice stream is passed to the voice browser 3 (arrow 310) and can also be passed to block 303 (arrow 311) to be relayed to the other users to provide an indication as to what input is currently being handled; unselected input is not relayed in this manner.

The selection block 304 can operate in a number of ways such as always taking the first to be started response from any user following the end of a particular voice output turn by the voice browser. An alternative is to arrange for the users to take turns in responding. Preferably, however, in order to achieve a degree of continuity, the voice service dialog is divided into sections (for example, by mark up tags in the voice pages) with all the voice input required to navigate a particular section being arranged to come from the same user (provided, of course they remain present and responsive); to this end, the voice browser provides a control input (dotted line 312 in FIG. 13) to the selection block to indicate when a new user can be selected.

Ideally, selection or combination of user input is done after interpretation of the input from all users. However, this requires significant voice browser resources to interpret the semantic content (albeit in context) of each user's input and then further resources to compare the inputs and determine what input is to be used to determine the further progress of the current dialog.

Of course, it would be possible to provide the speech recogniser and text-to-speech converter of the voice browser at each user or elsewhere in the communications infrastructure and have the communication session simply handle text-form voice input and output; the dialog manager of the voice browser would, however, remain interposed between the session control functionality and the voice page server.

An extension of the arrangement described above with respect to FIG. 13 is to join a user requesting a voice service in respect of a particular entity into a session with any other users currently using the voice service in respect of the same local entity and any other entities that have been logically associated with that entity, the voice inputs and outputs to and from the voice service being made available to all such users. Thus, for example, if two similar plants (not necessarily located near each other) are logically associated, users in dialog with each plant are joined into a common session with a single common voice service being applied for both plants. FIG. 13 depicts a user C at entity Y joined into the same session as users A and B at entity X. It is possible to provide such a common voice service with voice output passages specific to particular entities in which case such passages can have their distribution restricted to the users at the entities concerned.

Voice Out put Positioning

TO enhance the effect of dialogue with a dumb entity, the voice service sound output is advantageously generated such that it appears to be coming from the entity. This can be achieved by having multiple local loudspeakers in the locality of the entity, and assuming that their locations relative to the entity are known to the voice browser system or other means used to provide audio output control, controlling the volume from each speaker to make it appear as if the sound output is coming from the entity, at least in terms of azimuth direction. This is particularly useful where there are multiple voice-enabled dumb entities in the same area.

A similar effect (making the voice output appear to come from the dumb entity) can also be achieved for users wearing stereo-sound headsets provided the following information is known to the voice browser (or other element responsible for setting output levels between the two stereo channels):

location of the user relative to the entity (this can be determined in any suitable manner including by using a system such as GPS to accurately position the user, the location of the entity being fixed and known); and

the orientation of the user's head (determined, for example, using a magnetic flux compass or solid state gyros incorporated into the headset).

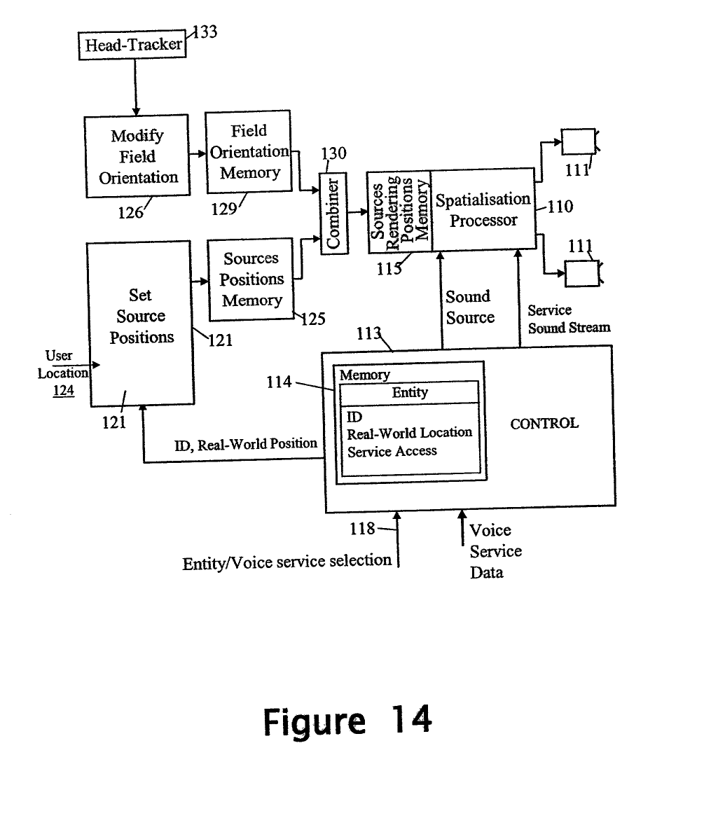

FIG. 14 shows apparatus that is operative to generate, through headphones, an audio field in which the voice service of a currently-selected local entity is presented through a synthesised sound source positioned in the audio field so as to appear to coincide (or line up) with the entity, the audio field being world-stabilised so that the entity-representing sound source does not rotate relative to the real world as the user rotates their head or body. The heart of the apparatus is a spatialisation processor 110 which, given a desired audio-field rendering position and an input audio stream, is operative to produce appropriate signals for feeding to user-carried headphones 111 in order to generate the desired audio field. Such spatialisation processors are known in the art and will not be described further herein.

The FIG. 14 apparatus includes a control block 113 with memory 114. Dialog output is only permitted from one entity (or, rather, the associated voice service) at a time, the selected entity/voice service being indicated to the control block on input 118. However, data on multiple local entities and their voice services can be held in memory, this data comprising for each entity: an ID, the real-world location of the entity (provided directly by that entity or from the associated voice service), and details of the associated voice service. For each entity for which data is stored in memory 114, a rendering position is determined for the sound source that is to be used to represent that entity in the audio field as and when that entity is selected.

The FIG. 14 apparatus works on the basis that the position of each entity-representing is specified relative to an audio-field reference vector, the orientation of which relative to a presentation reference vector can be varied to achieve the desired world stabihsation of the sound sources. The presentation reference vector corresponds, for a set of headphones, to the forward facing direction of the user and therefore changes its direction as the user turns their head. The user is at least notionally located at the origin of the presentation reference vector.

The spatialisation processor 110 uses the presentation reference vector as its reference so that the rendering positions of the sound sources need to be provided to the processor 110 relative to that vector. The rendering position of a sound source is thus a combination of the position of the source in the audio field judged relative to the audio-field reference vector, and the current rotation of the audio field reference vector relative to the presentation reference vector.

Because headphones worn by the user rotate with the user's head, the synthesised sound sources will also appear to rotate with the user unless corrective action is taken. In order to impart a world stabilisation to the sound sources, the audio field is given a rotation relative to the presentation reference vector that cancels out the rotation of the latter as the user turns their head. This results in the rendering positions of the sound sources being adjusted by an amount appropriate to keep the sound sources in the same perceived locations so far as the user is concerned. A suitable head-tracker sensor 133 (for example, an electronic compass mounted on the headphones) is provided to measure the azimuth rotation of the user's head relative to the world to enable the appropriate counter rotation to be applied to the audio field.

Referring again to FIG. 14, the determination of the rendering position of each entity representing sound source in the output audio field is done by injecting a sound-source data item into a processing path involving elements 121 to 130. This sound-source data item comprises an entity/sound source ID and the real-world location of the entity (in any appropriate coordinate system. Each sound-source data item is passed to a set-source-position block 121 where the position of the sound source is automatically determined relative to the audio-field reference vector on the basis of the supplied position information.

The position of each sound source relative to the audio field reference vector is set such as to place the sound source in the field at a position determined by the associated real-world location and, in particular, in a position such that it lies in the same direction relative to the user as the associated real-world location. To this end, block 121 is arranged to receive and store the real-world locations passed to it from block 113, and also to receive the current location of the user as determined by any suitable means such as a GPS system carried by the user, or nearby location beacons. The block 121 also needs to know the real-world direction of pointing of the un-rotated audio-field reference vector (which, as noted above, is also the direction of pointing of the presentation reference vector). This can be derived for example, by providing a small electronic compass on the headphones 111 (this compass can also serve as the head tracker sensor 133 mentioned above); by noting the rotation angle of the audio-field reference vector at the moment the real-world direction of pointing of vector 44 is measured, it is then possible to derive the real-world direction of pointing of the audio-field reference vector.

The decided position for each source is then temporarily stored in memory 125 against the source ID.

Of course, as the user moves in space, the block 121 needs to reprocess its stored real-world location information to update the position of the corresponding sound sources in the audio field. Similarly, if updated real-world location information is received from a local entity, then the positioning of the sound source in the audio field must also be updated.

Audio-field orientation modify block 126 determines the required changes in orientation of the audio-field reference vector relative to presentation reference vector to achieve world stabilisation, this being done on the basis of the output of the afore-mentioned head tracker sensor 133. The required field orientation angle determined by block 126 is stored in memory 129.

Each source position stored in memory 125 is combined by combiner 130 with the field orientation angle stored in memory 129 to derive a rendering position for the sound source, this rendering position being stored, along with the entity/sound source ID, in memory 115. The combiner operates continuously and cyclically to refresh the rendering positions in memory 115.

The spatialisation processor 110 is informed by control block 113 which entity is currently selected (if any). Assuming an entity is currently selected, the processor 110 retrieves from memory 15 the rendering position of the corresponding sound source and then renders the sound stream of the associated voice service at the appropriate position in the audio field so that the output from the voice service appears to be coming from the local entity.

The FIG. 14 apparatus can be arranged to produce an audio field with one, two or three degrees of freedom regarding sound source location (typically, azimuth, elevation and range variations). Of course, audio fields with only azimuth variation over a limited arc can be produced by standard stereo equipment which may be adequate in some situations.

The FIG. 14 apparatus is primarily intended to be part of the user's equipment, being arranged to spatialize a selected voice service sound stream passed to the equipment either as digitized audio data or as text data for conversion at the equipment, via a text-to-speech converter, into a digitized audio stream. However, it is also possible to provide the apparatus remotely from the user, for example, at the voice browser, in which case the user is passed spatialized audio streams for feeding to the headphones.

Making the voice service output appear to come from the dumb entity itself as described above enhances the user experience of talking to the entity itself. It maybe noted that this experience is different and generally superior to merely being provided with information in audio form about the entity (such as would occur with the audio rendering of a standard web page without voice mark up); instead, the present voice services enable a dialog between the user and the entity with the latter preferably being represented in first person terms.

1. A method of voice interaction with a nearby entity, comprising the steps of:
(a) associating a group of one or more entities with a separately-hosted voice service;
(b) upon a user approaching near to any entity of the group, initiating provision of the voice service to that user by joining the user into a communication session established for the service and common to all users of the voice service;
the voice service acting as voice proxy for said group with each user joined to the session interacting with the service through spoken dialog and hearing at least some of the same voice-service output as all other users joined to the session.

2. A method according to claim 1, wherein the voice service selects voice input from one user at any one time in order to determine its next voice output.

3. A method according to claim 2, wherein users do not hear voice input from other users except for the voice input selected by the voice service.

4. A method according to claim 2, wherein the voice service selects the voice input from each user currently joined to the session on a sequential basis.

5. A method according to claim 2, wherein the selected voice input is the first input received in response to a completed voice output turn by the voice service.

6. A method according to claim 2, wherein the voice service content is divided into sections each comprising at least one voice input and at least one voice output, the user providing the selected voice input being kept the same throughout the delivery of a section.

7. A method according to claim 1, wherein each user connected to the session hears voice input from all other such users and all voice output by the service.

8. A method according to claim 1, wherein the service provides voice output specific to a particular entity of said group, this output being provided only to the users near that entity.

9. A method according to claim 1, wherein the voice service is effected by the serving of voice pages in the form of text with embedded voice markup tags to a voice browser, the voice browser interpreting these pages and carrying out speech recognition of selected user voice input, text to speech conversion to generate voice output, and dialog management; the voice browser being disposed between a voice page server and an arrangement for selecting voice input from amongst the input received from all users and for distributing to the users the voice output of the voice browser.

10. A method according to claim 1, wherein in step (b) the initiating of service provision is effected by the transfer of service contact data to user equipment carried by the user, the user equipment then using the contact data to contact the voice service over a wireless connection.

11. A method according to claim 1, wherein in step (b) the initiating of service provision is effected by the transfer of user contact data from user equipment to a receiving device in the vicinity of the entity concerned, the user contact data being passed from the receiving device to the voice service to enable the latter to contact user equipment over a wireless connection.

12. A method according to claim 1, wherein in step (b) the initiating of service provision is effected by determining the relative locations of the user and said entities and initiating the voice service only when the user moves close to a said entity.

13. A method according to claim 1, wherein both voice input by a user to the service and voice output by the service to the user are effected by audio input and output means forming part of equipment carried by the user.

14. A method according to claim 1, wherein voice input by a user to the service is effected by audio input means forming part of equipment carried by the user, and voice output by the service to the user is effected by audio output means located in the locality of the entity concerned and separate from any equipment carried by the user.

15. A method according to claim 1, wherein both voice input by a user to the service and voice output by the service to the user are effected by audio input and output devices located in the locality of the entity concerned and separate from any equipment carried by the user.

16. A method according to claim 1, wherein voice service sound output to at least one user joined to the communication session is through multiple sound output devices controlled so that the sound appears to be originating from said local entity.

17. A method according to claim 1, wherein said multiple sound output devices are headphones worn by the user, the location of the voice service sound output in the audio field generated by the headphones being controlled to take account of the relative positions of the user and entity and rotations of the user's head.

18. A method according to claim 1, wherein said multiple sound output devices are loudspeakers associated with the locality of the entity rather than with the user and connected with the voice service through the communications infrastructure, the sound output from the loudspeakers being controlled in dependence on the relative positions of the user and entity.

19. A system for enabling verbal communication on behalf of a local entity with a nearby user, the system comprising:
audio output means either forming part of equipment carried by the user, or located in the locality of the local entity,
audio input means either forming part of equipment carried by the user, or located in the locality of the local entity,
communication means over which signals can be transferred respectively to and from the audio output and input means;
a voice service arrangement for providing a voice service associated with the entity but separately hosted, the voice service arrangement being arranged to deliver the voice service by providing voice input and output signals via the communications means to the audio input and output means thereby enabling a user to interact with the voice service through spoken dialog; and
service initiation means for initiating voice service delivery by the voice service arrangement to a user near the local entity;
the voice service arrangement including session control means for joining multiple users each near the same local entity or an entity of a group of associated entities, into a common voice-service communication session in respect of the same local entity or group of entities whereby such users hear at least some of the same voice-service output.

20. A system according to claim 19, wherein the session control means is operative to select voice input from one user at any one time for use by the voice service in determining its next voice output.

21. A system according to claim 20, wherein the session control means is operative only to pass on voice input from any user to other users when that voice input is selected for use by the voice service.

22. A system according to claim 20, wherein the session control means is operative to select voice input from each user currently joined to the session on a sequential basis.

23. A system according to claim 20, wherein the session control means is operative to take as the selected voice input the first input received in response to a completed voice output turn by the voice service.

24. A system according to claim 20, wherein the voice service content is divided into sections each comprising at least one voice input and at least one voice output, the session control means being operative to keep unchanged the user providing the selected voice input throughout the delivery of a section.

25. A system according to claim 19, wherein the session control means is operative to pass to each user connected to the session voice input from all other such users and all voice output by the service.

26. A system according to claim 19, wherein the voice service is arranged to provide voice output specific to a particular entity of said group, the session control means being operative to provide such output only to the users near that entity.

27. A system according to claim 19, wherein the voice service arrangement comprises:
a voice page server for serving voice pages in the form of text with embedded voice markup tags; and
a voice browser comprising:
a speech recognizer for carrying out speech recognition of user voice input received as voice signals;
a dialog manager for effecting dialog control on the basis of output from the speech recognizer and pages served by the voice page server; and
a text-to-speech converter operative to convert voice pages into voice output signals under the control of the dialog manager;
the voice browser being operatively disposed between the voice page server and the session control means.

28. A system according to claim 19, wherein the service initiation means comprises means for transferring service contact data to equipment carried by the user, and means at the user equipment for using the contact data to contact the voice service arrangement over the communication means.

29. A method according to claim 19, wherein the service initiation means comprises a receiving device in the vicinity of the entity, and means for transferring user contact data from user equipment to the receiving device, the receiving device being operative to pass the contact data over the communication means to the voice service arrangement to enable the latter to contact the user equipment over a wireless connection.

30. A method according to claim 19, wherein the service initiation means comprises comparison means for determining and comparing the locations of the user and said entities, and means for initiating the voice service only when the user moves close to a said entity as determined by the comparison means.

31. A system according to claim 19, wherein both the audio input and output means form part of the user equipment carried by the user.

32. A system according to claim 19, wherein the audio input means forms part of equipment carried by the user and the audio output means is located in the locality of said entity apart from the user equipment.

33. A system according to claim 19, wherein both the audio input and output means are located in the locality of said entity apart from the user equipment.

34. A system according to claim 19, wherein said audio output means comp rises multiple sound output devices and means for controlling the sound output such that it appears to be originating from said local entity.

35. A system according to claim 34, wherein said multiple sound output devices are headphones worn by the user, the location of the voice service sound output in the audio field generated by the headphones being controlled to take account of the relative positions of the user an d entity and rotations of the user's head.

36. A system according to claim 34, wherein said multiple sound output de vices are loudspeakers associated with the locality of the entity rather than with the user and connected with the voice service through a communications infrastructure., the sound output from the loudspeakers being controlled in dependence on the relative positions of the user and entity.
